(19) United States
(12) Patent Application Publication
(10) Pub. No.: US 2001/0004416 A1
(43) Pub. Date: Jun. 21, 2001

(54) Rare earth-doped optical fiber

(76) Inventors: Ki Tae Jeong, Daejeon (KR); Young Tark Lee, Daejeon (KR); Han Kyo Seo, Daejeon (KR); Jeong U. Jeon, Daejeon (KR); Seok Bong Ko, Daejeon (KR)

Correspondence Address: PENNIE & EDMONDS LLP, 1667 K STREET, N.W., WASHINGTON, DC, 20006, US

(21) Appl. No.: 09/739,399

(22) Filed: Dec. 19, 2000

(30) Foreign Application Priority Data
Dec. 20, 1999 (KR) 1999-59404

(51) Int. Cl. G02B 6/22

(52) U.S. Cl. 385/127; 385/123

(57) ABSTRACT

A rare earth-doped optical fiber comprises a cladding, a center core doped with a rare earth element, the center core having a refractive index higher than that of the cladding, and a ring-shaped core surrounding the center core without contact and having a refractive index higher than that of the cladding and lower than that of the center core.

### FIELD OF THE INVENTION

The present invention relates to a rare earth-doped optical fiber; and, more particularly, to a rare earth-doped optical fiber including an additional ring-shaped core in an outer region of a center core in order to increase a mode field diameter.

### DESCRIPTION OF THE PRIOR ART

Optical fibers include a core region that is surrounded by cladding. The core region has a larger refractive index than the cladding so that light is confined to that region as it is guided along the fiber.

Generally, the light is not reflected exactly at the interface between the core and the cladding but penetrates to some depths into the cladding before it is reflected back into the core. The depth of penetration varies depending on the refractive index. Typically, step index type single mode fiber shows such a tendency. The diameter to which the light penetrates while it is guided along the optical fiber is called mode field diameter (MFD). More specifically, an MFD of a single mode fiber for a given wavelength corresponds to a distance that reduces the intensity of transmitted radiation of the given wavelength to 1/e times the maximum intensity of the radiation.

In the fields of optical amplification or optical fiber laser, an optical fiber having a core region doped with a rare earth element has been proposed. Optical amplification using the rare earth-doped fiber is performed as follows. When a pumping light is introduced into an optical fiber having a core region doped with a rare earth element, the rare earth element is excited to a higher energy level. Then, if a signal light is allowed to impinge onto the rare earth element excited to the higher level, the rare earth element undergoes a transition to a lower energy level and a stimulated emission takes place. Thus, the signal light is amplified as it propagates through the rare earth-doped fiber.

FIG. 1 shows a typical example of a rare earth-doped fiber and a refractive index profile thereof. The rare earth-doped fiber includes a region A containing refractive index increasing element, e.g., Ge, Al, and has a stepped refractive index profile with a high numerical aperture, by which an overlap of the signal light and the rare earth-doped region can be minimized.

In order to achieve a high efficiency and a low noise level for such a rare earth-doped fiber, amplified spontaneous emissions should be minimized. Further, if the rare earth element included in the core is not completely transited to a population inversion state, it absorbs the signal light, thereby decreasing the efficiency.

Thus, as shown in FIG. 1, only a central region B of the core is doped with the rare earth element in order to prevent the absorption of the signal light. That is, only a region where a pumping intensity is sufficiently high is doped with the rare earth element.

However, control of dopant profile for small region of a core is difficult and high absorption coefficient is not readily achieved. Further, propagation loss increases as the concentration of Ge increases and losses at connection point with other optical ,fibers are also increased since MFD for signal light wavelength is decreased.

### SUMMARY OF THE INVENTION

It is, therefore, an object of the invention to provide a rare earth-doped fiber having a center core region and an additional ring shaped core region, in which pumping light travels along the center core region and signal light is guided through both core regions to thereby achieve substantially same effect as a conventional rare earth-doped optical fiber having a center core region of highly concentrated rare earth element.

In accordance with a preferred embodiment of the present invention, there is provided a rare earth-doped optical fiber which comprises a cladding, a center core doped with a rare earth element, the center core having a refractive index higher than that of the cladding, and a ring-shaped core surrounding the center core without contact, the ring-shaped core having a refractive index higher than that of the cladding and lower than that of the center core.

### BRIEF DESCRIPTION OF THE DRAWINGS

The above and other objects and features advantages of the present invention will become apparent from the following description given in conjunction with the accompanying drawings, wherein:

FIG. 1 is a typical example of a rare earth-doped fiber and a refractive index profile thereof;

FIG. 2 shows a cross-sectional view of an optical fiber in accordance with a preferred embodiment of the present invention;

FIG. 3 illustrates a refractive index profile of the optical fiber shown in FIG. 2; and

FIG. 4 presents a graph showing the difference between the MFD of the present Example, shown in solid line, and that of a comparative example, shown in broken line, according to prior art.

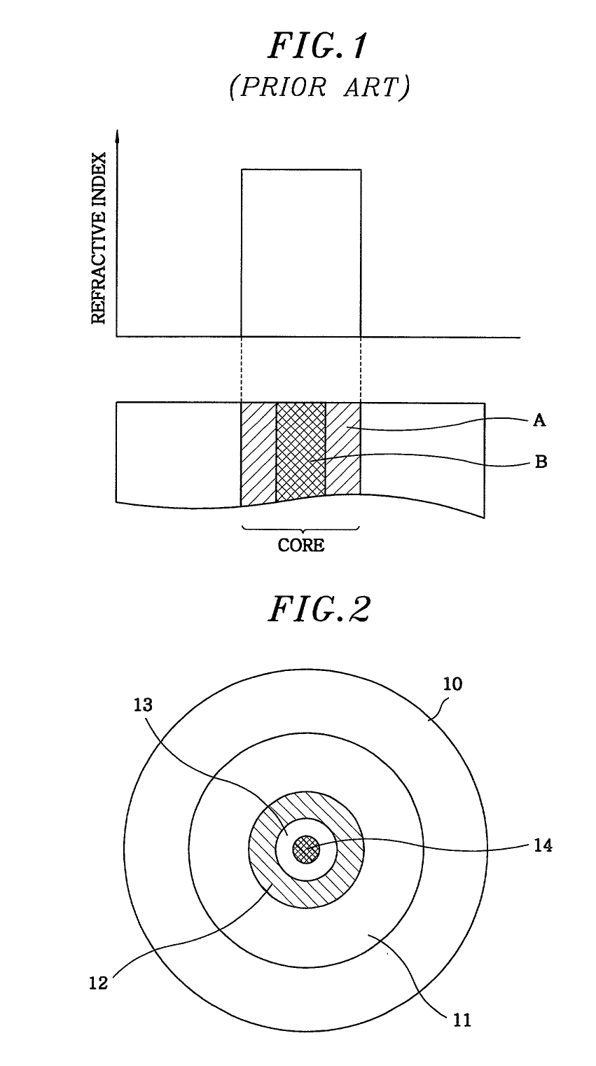

### DETAILED DESCRIPTION OF THE PREFERRED EMBODIMENTS

The preferred embodiments of the present invention will now be described in detail with reference to the accompanying drawings.

FIG. 2 shows a cross-sectional view of an optical fiber in accordance with a preferred embodiment of the present invention.

The optical fiber is coated with a polymer coating layer 10. The fiber also has a cladding 11, a ring-shaped core 12 and a center core 14. Between the ring-shaped core 12 and the center core 14, an intermediate region 13 that has a relatively low refractive index is arranged. The center core 14 and the ring-shaped core 12 have higher refractive indices than other regions, respectively, and a signal light is guided through these cores. If the fiber is a silica optical fiber, refractive index of cladding is same as that of pure silica and refractive index of the ring-shaped core 12 and the center core 14 are raised by adding refractive index increasing material such as Ge, P or Al.

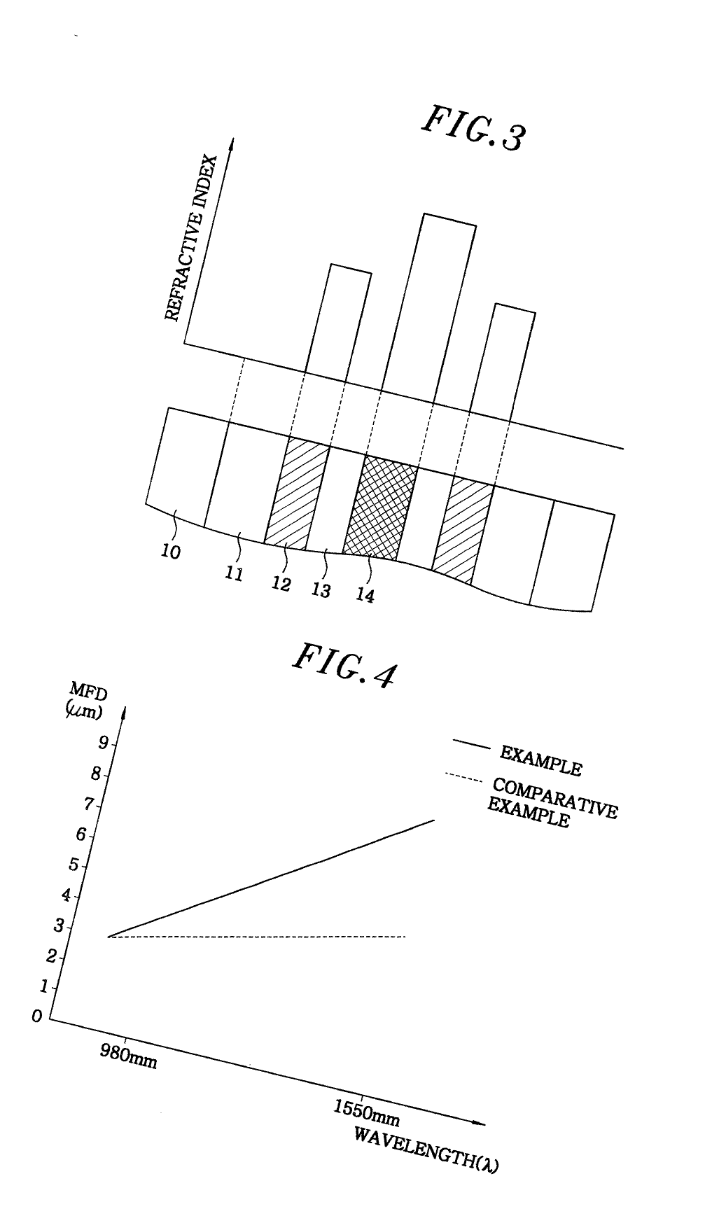

FIG. 3 is a refractive index profile of the optical fiber shown in FIG. 2. The center core 14 has a refractive index higher than that of the ring-shaped core 12. Preferably, the intermediate region 13 has a refractive index lower than those of the cores to thereby achieve a high efficiency. Further, the intermediate region 13 may have a refractive index lower than that of cladding 11. Though the optical fiber has a step index profile as shown in FIG. 3, it may has various profiles such as triangular shape, multi-diagonal shape or curved shape.

The center core 14 is doped with a rare earth element and may also contain Al, P or Yb. When a pumping light having shorter wavelength travels through the center core 14 doped with a rare earth element, the rare earth element is changed into an excited state. If the signal light is allowed to impinge onto the rare earth element before spontaneous emission occurs, the rare earth element undergoes a transition to a lower energy level and a stimulated emission occurs. Thus, the signal light is amplified as it propagates through the fiber.

The optical fiber in accordance with the preferred embodiment of the present invention, an overlap of the signal light and rare earth-doped region is relatively small compared with conventional optical fibers and thus a complete population inversion can be achieved. As a consequence, absorption of the signal light is decreased and thus a high efficiency can be achieved.

### EXAMPLE

An exemplary optical fiber in accordance with the present invention is described hereinafter.

Detailed specification of a silica optical fiber in accordance with the present invention is given in Table 1.

TABLE 1

| | DIAMETER | REFRACTIVE INDEX |
|---|---|---|
| | (nm) | DEFFRENCE |
| CENTER CORE | 2 | 0.018 |
| INTERMEDIATE | 5 | 0 |
| REGION | | |
| RING-SHAPE | 7 | 0.006 |
| CORE | | |
| CLADDING | 125 | 0 |

Characteristics of the silica optical fiber are given in Table 2.

TABLE 2

| | |
|---|---|
| CUTOFF WAVELENGTH (nm) | 960 |
| CONNECTION LOSS (dB) | Below 0.1 |
| MFD (nm) | 9.4 (1550 nm) |
| | 4.1 (980 nm) |

As shown in above Tables, the cutoff frequency of pumping light was 960 nm and thus a pumping light having a wavelength of 980 nm could be guided in single mode. Without additional assistance, conventional rare earth-doped fibers have a connection loss of 1 to 2 dB. In comparison with this, the present invention achieved great improvement.

FIG. 4 represents a graph showing a difference between an MFD of the present Example, shown in solid line, and that of a comparative example, shown in broken line, according to prior art. An MFD ratio of the present Example was

$$\frac{{MFD}_{1550}}{{MFD}_{980}} = \frac{9.4}{4.1} = 2.29$$

and that of the comparative example was

$$\frac{{MFD}_{1550}}{{MFD}_{980}} = \frac{5.5}{3.5} = 1.57 .$$

As shown in FIG. 4, the present Example had an MFD and an MFD difference between the wavelength of the pumping light (980 nm) and the signal light (1550 nm) which were greater than those of the comparative example. The MFD was about 1.7 times that of the conventional optical fiber.

According to the present invention, since the pumping light travels through the center core, thereby causing the rare earth element contained therein to be excited, and since the signal light propagates through the ring-shaped core as well as the center core, the optical fiber in accordance with the present invention has a greater MFD than the conventional optical fiber. Thus, restrictions to energy accumulation capacity due to a nonlinear effect is alleviated while an overlap of the signal light and the rare earth-doped region is relatively decreased. Furthermore, absorption coefficient is increased as a rare earth-doped area is increased. Connection loss can also be minimized since the MFD of the optical fiber of the present invention is similar to that of the single mode fiber.

Although the invention has been shown and described with respect to the preferred embodiments, it will be understood by those skilled in the art that various changes and modifications may be made without departing from the spirit and scope of the invention as defined in the following claims.

What is claimed is:

1. A rare earth-doped optical fiber, comprising:
a cladding;
a center core doped with a rare earth element and having a refractive index higher than that of the cladding; and
a ring-shaped core surrounding the center core without contact and having a refractive index higher than that of the cladding and lower than that of the center core.

2. The rare earth-doped optical fiber of claim 1, the center core further containing aluminum.

3. The rare earth-doped optical fiber of claim 1, the center core further containing phosphorus.

4. The rare earth-doped optical fiber of claim 1, the center core further containing ytterbium.

5. The rare earth-doped optical fiber of claim 1, further comprising one or more ring-shaped regions.

6. The rare earth-doped optical fiber of claim 1, further comprising an intermediate region arranged between the center core and the ring-shaped core, the intermediate region having a refractive index lower than those of the center core and the ring-shaped core.
